(19) United States
(12) Patent Application Publication
(10) Pub. No.: US 2026/0191191 A1
(43) Pub. Date: Jul. 9, 2026

(54) METHOD FOR INACTIVATING ENVELOPED VIRUSES

(71) Applicant: Merck Patent GmbH, Darmstadt (DE)

(72) Inventors: Alice Antonello, Darmstadt (DE); Almut Rapp, Darmstadt (DE); Corinne Miller, Bedford, MA (US)

(21) Appl. No.: 19/133,289

(22) PCT Filed: Nov. 27, 2023
(86) PCT No.: PCT/EP2023/083091

§ 371 Date: May 28, 2025

Related U.S. Application Data
(60) Provisional application No. 63/385,237, filed on Nov. 29, 2022.

(51) Int. Cl. A01N 31/02; A01N 25/02; A01P 1/00

(52) U.S. Cl. CPC A01N 31/02; A01N 25/02; A01P 1/00

(57) ABSTRACT

The present invention relates to a method for inactivating enveloped viruses by treatment with non-ionic surfactants, namely secondary fatty alcohol ethoxylates.

The present invention relates to a method for inactivating enveloped viruses by treatment with non-ionic surfactants, namely secondary fatty alcohol ethoxylates.

Viral contamination is a major safety concern for biologic therapeutics produced in mammalian cell culture or extracted from human plasma. Contamination of cell culture can originate from the cell line itself, which is commonly of rodent origin since retrovirus-like particles are encoded by their genomes. Adventitious contamination can be introduced into cell culture during the manufacturing process via contaminated cell substrates, raw materials, culture media, or operators. Viruses can be present in human blood and human plasma.

Virus clearance of biologic therapeutic production processes through both inactivation and physical removal is crucial to ensure the safety of biologics for patients. The manufacturing of therapeutics is regulated by the ICH-Q5A (EMEA. 2013. “Viral Safety Evaluation of Biotechnology Products Derived from Cell Lines of Human or Animal Origin.” Pp. 92-103 in ICH Q5 A (R1)). This document includes orthogonal approaches of viral clearance, such as low pH hold, solvent/detergent treatment, nanofiltration and chromatography.

Detergent or solvent/detergent inactivation is effective against enveloped viruses because the detergents solubilize the membrane lipids that create the outer envelope layer. This envelope allows the virus to identify, bind, enter, and infect target host cells. Without the envelope, destroyed by the surfactant micelles, the virus cannot anymore infect cells, replicate and propagate (ASTM E3042-16 “Standard Practice for Process Step to Inactivate Rodent Retrovirus with Triton™ X-100 Treatment.”).

Filtration and chromatography can typically remove all types of viruses, including non-enveloped viruses. During bioprocessing, a combination of removal and inactivation methods is applied. Typically, a virus removal or inactivation step is considered effective and robust if it can achieve 24 log reduction of infectious virus (see ASTM E3042-16 “Standard Practice for Process Step to Inactivate Rodent Retrovirus with Triton™ X-100 Treatment.”) Detergent-based virus inactivation is not routinely employed in recombinant mAb processes, in which low-pH exposure is more commonly used, except in cases where the mAb molecule does not exhibit sufficient stability under low-pH conditions. Detergent-based inactivation is routinely used as a dedicated virus inactivation step in plasma processes for purification of plasma proteins.

For many years, Triton™ X-100 detergent (Polyoxyethylene p-(1,2,3,3-tetramethylbutyl) phenyl ether) has been commonly used as a highly effective detergent for virus inactivation. However, after purification of the desired protein, the media used in the bioprocesses are discharged to the wastewater and the detergent starts to degrade. One of the degradation products of Triton™ X-100 is 4-tert-octylphenol, which mimics the hormone estradiol and leads to harmful effects to the endocrine system of fishes.

In 2017, octylphenol ethoxylates (OPE) were added to the European Authorization list (Annex XIV) of REACH (Registration, Evaluation, Authorization and Restrictions of Chemicals). Annex XIV is a list of banned substances in the EU. After January 2021, OPE products, including Triton™ X-100 detergent, are prohibited in the EU by the European Chemicals Agency (ECHA), unless authorization was granted by the authorities, or the intended use is exempt from authorization.

Consequently, alternative, environmentally compatible detergents for viral inactivation are required. Many detergents have been suggested and tested for this application.

In WO2015/073633 the general idea of using ecofriendly detergents for virus inactivation is brought up and numerous detergents are suggested as potentially suitable.

US20210032567 suggests certain non-phenolic polyoxyethylene ether detergents as suitable substitutes.

In EP3456352 certain zwitterionic detergents are disclosed for inactivating enveloped viruses.

US2022/0106573 provides a list of different zwitterionic and non-ionic detergents for virus inactivation.

WO2021/118900 is focused on the use of undecyl alkyl glycoside for virus inactivation.

This shows that there is a huge requirement for effective detergents for virus inactivation. But up to now no ideal solution was found. The detergents have to fulfil numerous requirements in addition to their ability to efficiently inactivate enveloped viruses and so far, the ideal candidate has not been identified.

It has now been found that a certain group of compounds is especially suitable for inactivating enveloped viruses.

The present invention is thus directed to a method for inactivating enveloped viruses in a sample by
a) Providing the sample
b) Adding to the sample one or more compounds of Formula I at a final overall concentration above their CMC.
c) Incubating the mixture

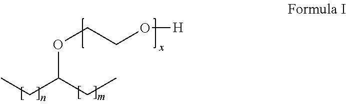

with x=7 to 15
and n+m=8 to 12

Preferably x=8 to 10, in a very preferred embodiment x=9.

In another preferred embodiment the compound is a C11-C15 secondary alcohol ethoxylate according to CAS 68131-40-8 and/or a C12-C14 secondary alcohol ethoxylate according to CAS 84133-50-60.

In a preferred embodiment the sample comprises a target protein, preferably an antibody.

In a preferred embodiment the incubation in step c) is performed for a time between 5 minutes and 6 hours.

In a preferred embodiment the incubation is step c) is performed at a temperature between 4 and 25° C.

In a preferred embodiment, in step c) the pH of the sample during incubation is between 5.5 and 8.

In a preferred embodiment the overall concentration of the one or more compounds according to Formula I is between 0.05 and 2% (w/v, weight per volume), more preferred between 0.1 and 1% (w/v). w/v means g solute/100 mL solution, e.g. 2% w/v means 2 g/100 mL.

In one embodiment, in step b), in addition to the one or more compounds according to Formula I a solvent is added to the sample.

In one embodiment the sample is a clarified harvest a chromatography pool or a plasma sample.

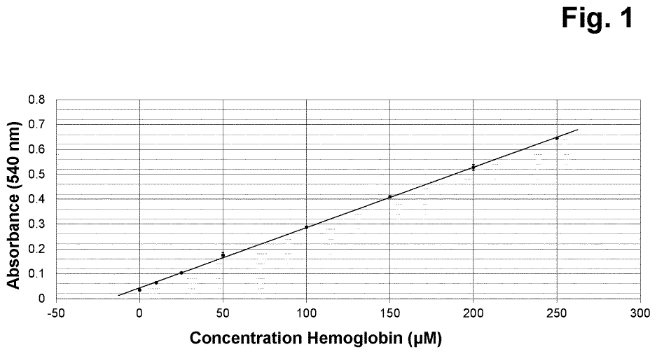

FIG. 1 shows the calibration curve for the absorbance versus hemoglobin concentration for the hemolysis assay of Method 5.

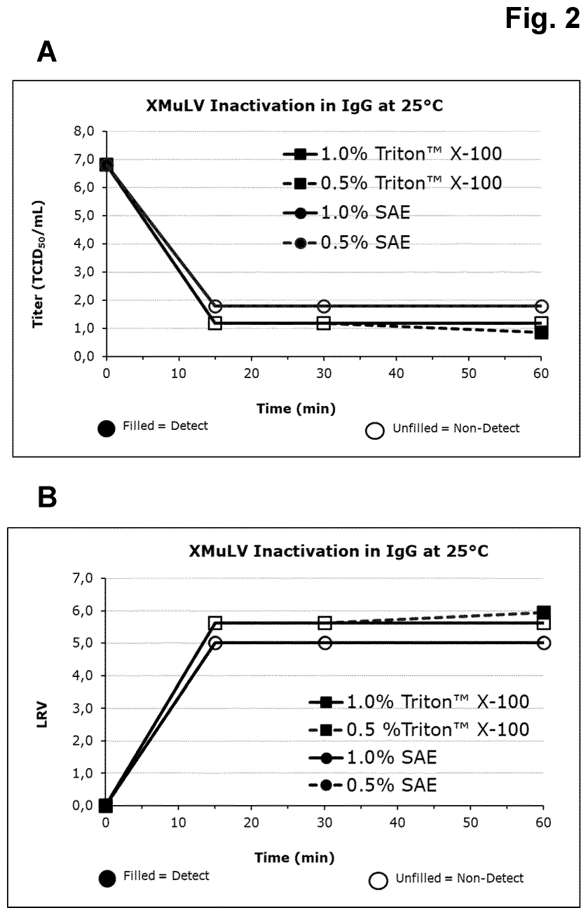

FIGS. 2 to 8 and 13 to 16 show results of virus inactivation experiments. Further details can be found in Example 1.

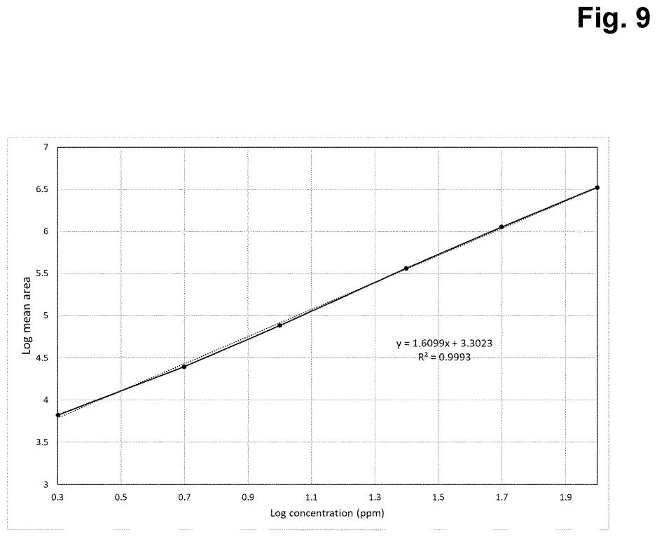

FIG. 9 shows the calibration curve for detergent detection with mean peak area versus concentration. Further details can be found in Example 2.

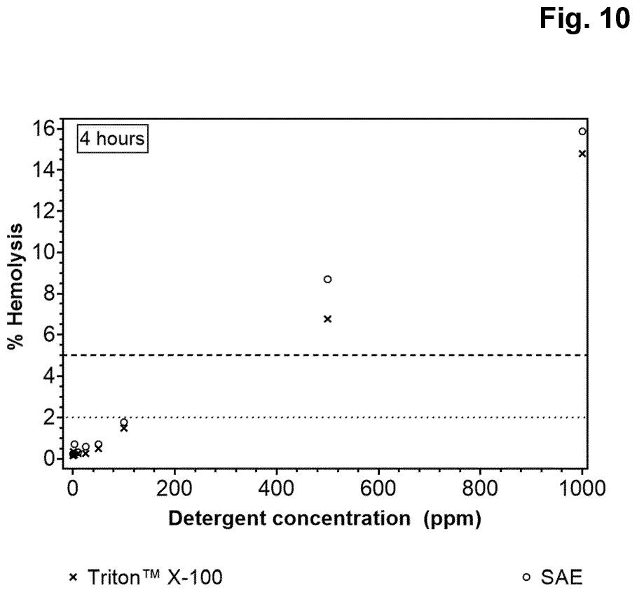

FIG. 10 shows the hemolysis percentage as a function of detergent concentration. % Degradation after 4 hours. Further details can be found in Example 4.

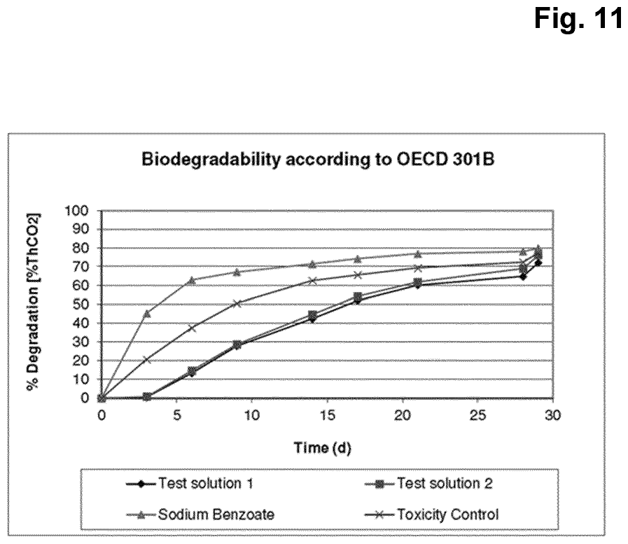

FIG. 11 shows the % degradation (% ThCO₂) vs time during the biodegradability assays according to the OECD 301B. Further details can be found in Example 5.

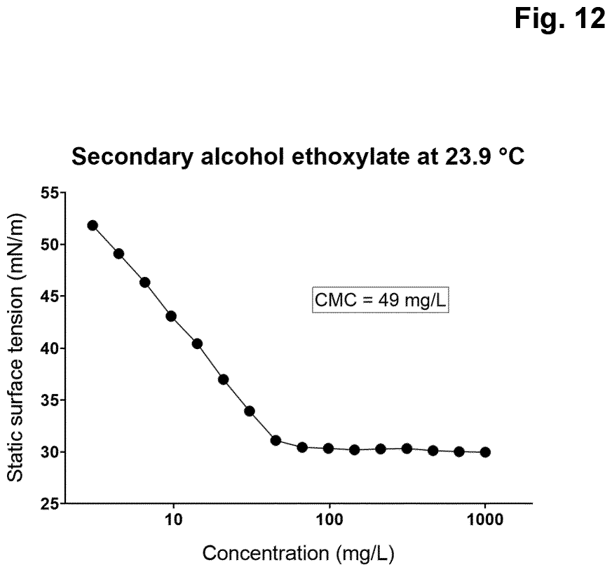

FIG. 12 shows the plot static surface tension as a function of secondary alcohol ethoxylate concentration. This plot is employed to determine the critical micelle concentration of the detergent (CMC). Further details can be found in Example 6.

### DEFINITIONS

Before describing the present invention in detail, it is to be understood that this invention is not limited to specific compositions or process steps, as such may vary. It must be noted that, as used in this specification and the appended claims, the singular form “a”, “an” and “the” include plural referents unless the context clearly dictates otherwise. Thus, for example, reference to “a virus” includes a plurality of viruses and reference to “an antibody” includes a plurality of antibodies and the like.

Unless defined otherwise, all technical and scientific terms used herein have the same meaning as commonly understood by one of ordinary skill in the art to which this invention is related. The following terms are defined for purposes of the invention as described herein.

Surfactants are defined as “surface active molecules”. The term “surfactant” as used herein refers to compounds that lower the surface tension between two liquids or between a liquid and a solid. Surfactants may act as detergents, wetting agents, emulsifiers, foaming agents, and dispersants.

A detergent is defined as a surfactant or a mixture containing one or more surfactants having cleaning properties in dilute solutions.

Detergents especially have the ability to permeabilize lipid membranes.

Micelles are defined as “surfactant aggregates formed in solution, which exist in equilibrium with the molecules or ions from which they are formed”. The critical micelle concentration (CMC) is defined as “relatively small range of concentrations separating the limit below which virtually no micelles are detected and the limit above which virtually all additional surfactant molecules form micelles”. (IUPAC. 2008a. “Critical Micelle Concentration.” The IUPAC Compendium of Chemical Terminology 1077:2014./IUPAC. 2008b. “Micelle.” The IUPAC Compendium of Chemical Terminology 1077:3889.). Above the CMC virtually all additional detergents added to the system go to micelles. The value of the CMC for a given detergent in a given medium depends on temperature, pressure, and (sometimes strongly) on the presence and concentration of other surface-active substances and electrolytes.

Viruses are classified as enveloped and non-enveloped viruses. Enveloped viruses have a capsid enclosed by a lipoprotein membrane or “envelope”. This envelope is made up of host cell proteins and phospholipids as well as viral glycoproteins which coat the virus as it buds from its host cell. This envelope allows the virus to identify, bind, enter, and infect target host cells. However, because of this membrane, enveloped viruses are susceptible to inactivation methods, while non-enveloped viruses are more difficult to inactivate. Enveloped viruses include such virus families as Herpesvirdae, Poxviridae, Hepadnavirdae, Flavivirdae, Togavirdae, Coronaviridae, Orthomyxoviridae, Paramyxoviridae, Rhabdovirdae, Bunyaviridae, Filovirdae, Retrovirdae; and such viruses as human immunodeficiency, sindbis, herpes simplex, pseudorabies, sendai, vesicular stomatitis, West Nile, bovine viral diarrhea, a corona, equine arthritis, severe acute respiratory syndrome, Moloney murine leukemia, and vaccinia.

Enveloped virus families are represented in general by model viruses such as xenotropic murine leukemia virus (XMuLV), model for the retrovirus, bovine viral diarrhea virus (BVDV), model for the hepatitis C virus, and pseudorabies virus (PRV), model for the herpesvirus.

Methods to detect viral infectivity are known in the art. A commonly used method is the Tissue Culture Infectious Dose 50% (TCID50) assay. This assay determines the infectious virus titer of a sample by measuring frequency of infection at different sample dilutions.

As used herein, and unless stated otherwise, the term “sample” refers to any composition or mixture which potentially contains enveloped viruses and in which such viruses shall be inactivated. Preferably the sample comprises a target compound. Samples may be derived from biological or other sources. Biological sources include eukaryotic and prokaryotic sources, such as plant and animal cells, blood, tissues and organs. The sample may also include diluents, buffers, detergents, and contaminating species, debris and the like that are found mixed with the target compound. The sample may be “partially purified” i.e., having been subjected to one or more purification steps, such as filtration steps or chromatography steps or may be obtained directly from a host cell or organism e.g., the sample may comprise harvested cell culture fluid. In one embodiment the sample may be a clarified harvest. A harvest is typically originating from a cell culture and is partially purified e.g., by filtration so that it comprises e.g., relatively small cell constituents, chemicals from the preceding treatment steps, RNA, proteins and endotoxins. Preferably the sample is a liquid sample like a solution or a suspension.

As used herein the term “target compound” refers to any molecule, substance or compound that shall be isolated, separated or purified from one or more other components, e.g. impurities, in a sample. In the production and/or purification process the target compound is typically present in an aqueous liquid. Beside the target compound said liquid may comprise one or more impurities. The liquid may also be called sample. The composition of the liquid may change during production and/or purification depending on the process steps that are performed. After a chromatographic step the liquid typically comprises other solvents than before because of the eluent used in the chromatographic step. A target molecule may be a high molecular weight compound like a protein, for example recombinant or natural proteins, e.g. an antibody or a non-enveloped virus like AAV.

Adeno-associated virus (AAV) is a member of the Parvoviridae family. Multiple serotypes of AAV exist and offer varied tissue tropism. Known serotypes include, for example, AAV1, AAV2, AAV3, AAV4, AAV5, AAV6, AAV7, AAV8, AAV9, AAV10 and AAV11. In AAV production it might be necessary to inactive certain helper viruses or other enveloped viruses.

The term “antibody” refers to a protein which has the ability to specifically bind to an antigen. “Antibody” or “IgG” further refers to a polypeptide substantially encoded by an immunoglobulin gene or immunoglobulin genes, or fragments thereof, which specifically bind and recognize an analyte (antigen). The recognized immunoglobulin genes include the kappa, lambda, alpha, gamma, delta, epsilon and mu constant region genes, as well as the myriad immunoglobulin variable region genes. Light chains are classified as either kappa or lambda. Heavy chains are classified as gamma, mu, alpha, delta, or epsilon, which in turn define the immunoglobulin classes, IgG, IgM, IgA, IgD, and IgE, respectively.

An exemplary immunoglobulin (antibody) structural unit is composed of two pairs of polypeptide chains, each pair having one “light” (about 25 kD) and one “heavy” chain (about 50-70 kD), said chains being stabilized, for example, by interchain disulfide bonds. The N-terminus of each chain defines a variable region of about 100 to 110 or more amino acids primarily responsible for antigen recognition. The terms variable light chain (V_{L}) and variable heavy chain (V_{H}) refer to these light and heavy chains respectively.

Antibodies may be monoclonal or polyclonal and may exist in monomeric or polymeric form, for example, IgM antibodies which exist in pentameric form and/or IgA antibodies which exist in monomeric, dimeric or multimeric form. Antibodies may also include multispecific antibodies (e.g., bispecific antibodies), and antibody fragments so long as they retain, or are modified to comprise, a ligand-specific binding domain. The term “fragment” refers to a part or portion of an antibody or antibody chain comprising fewer amino acid residues than an intact or complete antibody or antibody chain. Fragments can be obtained via chemical or enzymatic treatment of an intact or complete antibody or antibody chain. Fragments can also be obtained by recombinant means. When produced recombinantly, fragments may be expressed alone or as part of a larger protein called a fusion protein. Exemplary fragments include Fab, Fab′, F(ab′)2, Fc and/or Fv fragments. Exemplary fusion proteins include Fc fusion proteins. According to the present invention fusion proteins are also encompassed by the term “antibody”.

In some embodiments, an antibody is an Fc region containing protein, e.g., an immunoglobulin.

The term “chromatography” refers to any kind of technique which separates an analyte of interest (e.g. a target compound) from other molecules present in a sample as a result of differences in rates at which the individual components of the mixture bind to and/or migrate through a chromatography matrix under the influence of a moving phase. A chromatography pool is the whole or preferably a certain part of the eluent exiting the chromatography matrix. Typically, the chromatography pool comprises the target compound.

A “buffer” is a solution that resists changes in pH by the action of its acid-base conjugate components. Various buffers which can be employed depending, for example, on the desired pH of the buffer are described in Buffers. A Guide for the Preparation and Use of Buffers in Biological Systems, Gueffroy, D., ed. Calbiochem Corporation (1975). Non-limiting examples of buffers include MES, MOPS, MOPSO, Tris, HEPES, phosphate, acetate, citrate, succinate, and ammonium buffers, as well as combinations of these.

Secondary alcohol alkoxylates contain an ethylene oxide chain attached to a secondary alcohol. The secondary alcohol alkoxylates to be used in the method of the present invention are secondary alcohol ethoxylates made from secondary alcohols with 11 to 15 carbons and carrying 7 to 15 ethylene oxide units. An especially preferred group of such secondary alcohol ethoxylates is shown in Formula II comprising 9 ethylene oxide units.

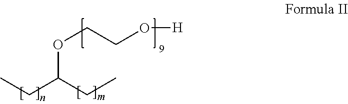

Such compounds are commercially available as Tergitol™ 15-S-9, The Dow Chemical Company or Deviron® 13-S9, Merck KGaA, Germany.

The term “inactivating enveloped viruses” as used herein refers to disrupting the ability of the lipid-enveloped virus to infect cells. As will be understood by a person skilled in the art, the ability of a lipid-enveloped virus to infect cells, i.e. the infectivity of a lipid-enveloped virus, is typically assessed by determining the number of infectious virus particles in a liquid. Hence, the term “inactivating an enveloped virus” as used herein refers to reducing the number of infectious virus particles in a solution.

The term “Log reduction value” can be used as a measure of the reduction of infectious virus particles in a liquid. As used herein, the “Log reduction value” or “LRV” is defined as the logarithm (base 10) of the ratio of infectious virus particles before virus inactivation to infectious virus particles after virus inactivation. The LRV value is specific to a given type of virus. For example, the LRV can be determined by determining the number of infectious virus particles in a liquid before and after subjecting the liquid to the method for virus inactivation according to the present invention.

### DETAILED DESCRIPTION

Many viruses have viral envelopes covering their protein capsids. The envelopes typically are derived from portions of the host cell membranes (phospholipids and proteins) but include some viral glycoproteins. Functionally, viral envelopes are used to help viruses enter host cells. Glycoproteins on the surface of the envelope serve to identify and bind to receptor sites on the host's membrane. The viral envelope then fuses with the host's membrane, allowing the capsid and viral genome to enter and infect the host. The lipid bilayer envelope of viruses is relatively sensitive to detergents. Provided herein in various aspects and embodiments of the invention is a method for inactivating enveloped viruses by
a) Providing a sample which potentially comprises enveloped viruses
b) Incubating the sample of step a) with one or more compounds of Formula I at a final concentration above their CMC.
c) Incubating the mixture

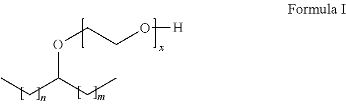

with x=7 to 15
and n+m=8 to 12

The sample may be any liquid sample. In case the original sample is not present as a liquid a solvent might be added, typically water or an aqueous buffer. Preferably the sample comprises a target compound like a protein or an AAV. The sample might result from biotherapeutic manufacturing or from human plasma. Consequently, the sample may be blood or may contain blood or a blood fraction, may be plasma or may contain plasma or a plasma fraction, may be serum or may contain serum or a serum fraction, may be cell culture medium or may contain cell culture medium, may be a buffer or may contain a buffer. The liquid may also be a process intermediate, e.g. a process intermediate in the preparation of a biopharmaceutical drug. Such process intermediates might result from cell culture, filtration processes, centrifugation processes or chromatography processes. The virus inactivation for mAb processing is regulated by the ASTM E3042—16 “Standard Practice for Process Step to Inactivate Rodent Retrovirus with Triton™ X-100 Treatment”. The virus inactivation during plasma processing is a practice implemented since the 1980s and reported in literature, such as in Bumouf, Thierry. 2007. “Modern Plasma Fractionation.” Transfusion Medicine Reviews 21(2):101-17. doi: 10.1016/j.tmrv.2006.11.001. Preferably, the cell culture harvest and the plasma are clarified before the virus inactivation step.

The sample is then incubated with one or more detergents according to Formula I.

Detergent micelles inactivate enveloped viruses by solubilizing the lipid membrane and thus destroying infectivity. It is crucial that the detergent concentration is above the CMC to ensure the presence of micelles.

In the method of the present invention, the overall concentration of the one or more detergents according to Formula I in the sample is preferably between 0.05 and 2% w/v, more preferably between 0.1 and 1%, very preferably between 0.5 and 1%.

In one embodiment, a solvent is added to the sample in addition to the one or more detergents according to Formula I. The solvent acts as a cosurfactant and promotes the contact between the micelles and the lipid membrane. Generally, without limitation, an ether, an alcohol, an alkylphosphate like a dialkylphosphate or a trialkylphosphate, or any combination thereof can be employed.

Examples of ether solvents include those having the formula R1-O—R2, wherein, R1 and R2 are independently C1-C18 alkyl or C1-C18 alkenyl which can contain an oxygen or sulfur atom, preferably C1-C18 alkyl or C1-C18 alkenyl. Non-limiting examples of ethers include dimethyl ether, diethyl ether, ethyl propyl ether, methyl-butyl ether, methyl isopropyl ether and methyl isobutyl ether. Non-limiting examples of alcohols include methanol, ethanol, propanol, isopropanol, n-butanol, isobutanol, n-pentanol and the isopentanols. Alkylphosphate solvents include those having C1-C18 alkyl groups or C1-C18 alkenyl groups, either of which may contain an oxygen or sulfur atom. Non-limiting examples of alkylphosphates include dialkylphosphates like di-(n-butyl)phosphate, di-(t-butyl)phosphate, di-(n-hexyl)phosphate, di-(2-ethylhexyl)phosphate, di-(n-decyl)phosphate, or ethyl di(n-butyl) phosphate; and trialkylphosphates like tri-(n-butyl)phosphate, tri-(t-butyl)phosphate, tri-(n-hexyl)phosphate, tri-(2-ethylhexyl)phosphate, or tri-(n-decyl)phosphate.

Very preferably in this invention, TnBP (tri-n-butyl phosphate) is employed as a solvent.

In case a solvent is added to the process to increase the virus inactivation efficacy, the concentration of the solvent is preferably between 0.3 and 1% w/v, very preferred around 0.3%.

The addition of a solvent is especially preferred for virus inactivation in case the sample is plasma or contains plasma or is a plasma fraction.

The pH of the sample when being mixed and incubated with the detergent is typically not critical. Preferably, the pH is between pH 5.5 and 8.

For the inactivation to efficiently take place the mixture of the sample and the detergent and optionally an additional solvent is incubated. The incubation time is typically between 5 min and 6 h. In biopharma production, e.g. the production of recombinant proteins, it is typically up to 60 min, preferably between 5 and 60 min. In plasma processing is typically up to 6 hours, preferably between 4 and 6 h, most preferably around 4 hours.

The temperature during the virus inactivation step is typically between 2 and 37° C., preferably between 4 and 25° C., very preferably between 15 and 25° C.

The method of the present invention typically results in at least a 4 Log reduction value (LRV) for at least one virus. Preferably it results in a 5 Log reduction value.

After virus inactivation the sample might be subjected to further process steps e.g. for purifying the target compound. It is for example possible to add a filtration or a chromatography step for also removing the inactivated viruses as well as the detergents and optional solvents.

The crucial point is e.g. for biopharma production of recombinant proteins that at the end of the downstream process all viruses must be inactivated, and the detergent must be removed to avoid any risk for the patient. The detergent can be removed during the chromatography steps performed to purify the product, such as affinity chromatography and ion-exchange chromatography. It is important to employ a quantitative method capable of detecting traces of detergent at the end of the process to not cause harm to the patient.

According to WHO Technical Report Series 924, the permitted level of Triton™ X-100 is between 3 and 25 ppm, depending on volume and frequency of infusion.

Also the detergents used according to the method of the present invention can be removed by methods like affinity chromatography and ion-exchange chromatography to the same level as required for Triton™ X-100.

In addition, it was found that the detergents used in the method of the invention beside the advantage of easy removal have a comparatively low CMC compared with other detergents and do not show any precipitation issues. They consequently combine a very good efficiency for virus inactivation and an easy handling.

The present invention is further illustrated by the following figures and examples, however, without being restricted thereto.

The entire disclosure of all applications, patents, and publications cited above and below as well as corresponding US patent application U.S. 63/385,237, filed on Nov. 29, 2022, are hereby incorporated by reference.

### EXAMPLES

The following examples represent practical applications of the invention.

### Methods

### Method 1: Virus Inactivation Studies

Model Virus and Indicator Cells
   Xenotropic murine leukemia virus (XMuLV, provided by Charles River Laboratories) high concentration stocks were generated by infecting Mv1Lu cells (ATCC® CCL-64) according to internal propagation and purification methods. XMuLV is considered a relevant model virus for endogenous enveloped retroviruses or retrovirus-like particles produced by rodent cells, which are typically used for production of biotherapeutic proteins. For the infectious virus assay, the indicator cell line PG-4 (ATCC®, CRL-2032) is used.
   Pseudorabies virus (PRV; ATCC® VR-135) high concentration stocks were generated by infecting Crandall-Rees Feline Kidney (CRFK) cells (ATCC® CCL-94) according to internal propagation and purification methods. PRV is a model virus for Herpesviruses. For the infectious virus assay, CRFK cells are also used as the indicator cells.
   Bovine viral diarrheal virus (BVDV; ATCC® VR-534) high concentration stocks were generated by infecting Madin-Darby bovine kidney (MDBK) cells (ATCC® CCL-22) according to internal propagation and purification methods. BVDV is considered a model virus for togavirus and flavivirus contaminants, including Hepatitis C, a potential virus contaminant in human plasma. For the infectious virus assay, MDBK cells are also used as the indicator cells.
   Matrices. Studies were performed in an IgG at 10 mg/mL in a sodium phosphate buffer, used to model a mAb feed. In addition, studies were performed in a fractionated plasma feed and a CHO (Chinese Hamster Ovary) cell culture clarified harvest. “Cryopoor” human plasma was prepared by slowly thawing bottles of human plasma at 2-8° C., followed by centrifugation at 6,000×g for 30 min at 2-4° C. to pellet precipitated protein and insoluble debris. CHO clarified harvest was prepared from cell culture fluid harvested from a suspension culture of CHO cells grown in a large-scale bioreactor, which was subsequently clarified with depth filtration media to remove cell debris and some level of host-cell proteins and nucleic acid.
   Cytotoxicity determination. Detergents are expected to be cytotoxic toward mammalian cells, which contain a lipid envelope. In addition, different matrices may exhibit some degree of cytotoxicity toward indicator cells used for infectious virus quantitation or may impart interference with virus infection of indicator cells. Prior to conducting virus inactivation studies, experimental matrices and matrices containing potential residual levels of detergent are assessed for any potential cytotoxic or virus inhibition effects. Feed matrices containing experimental concentrations of detergent are processed over a detergent-removal column (Pierce Detergent Removal Spin Column, Thermo Scientific Cat #87778/9). Post-column material is serially diluted and added to indicator cells, both in the absence and presence of virus, and cultures are observed for any cytotoxic effects which would obscure the assessment of virus-induced cytopathic effect.
   Detergent-mediated virus inactivation. Virus is added at a target concentration to the matrix, with a sample taken immediately to determine initial infectious virus titer. A concentrated detergent or a solvent/detergent mixture is added to the virus-containing matrix, with initial thorough mixing. The mixture is incubated at the target temperature, and samples are removed at desired time points. Samples are either pre-diluted immediately with culture medium or are immediately processed over a detergent removal column to terminate the detergent inactivation in the sample. All samples are then assayed for infectivity with the TCID₅₀ assay. The minimum dilution needed to eliminate any cytopathic effect is determined, and this dilution is subsequently used as the “pre-dilution” for the TCID₅₀ infectious virus assay.
   TCID₅₀ assay. Infectious virus titers are determined with the Tissue Culture Infectious Dose 50% assay. Tissue culture plates (96-well) are seeded with 2.5×10³ cells/well of indicator cells in 100 μL/well and incubated for approx. 16 h. Wells are then inoculated with 10-fold serial dilutions (n=8 wells for each dilution) of the sample material, after the sample is pre-diluted to the required level to negate any cytotoxic effects, using 100 μL/well. For many studies, large volume plating of samples that are expected to contain very low levels of infectious virus is performed to increase assay sensitivity. After incubation at 37° C. in 5% CO₂ for 7-9 days, infected wells are visually inspected for cytopathic effects (CPE). The frequency of infected wells at each dilution is determined, and then original sample titers are determined by statistical methods, including the Spearmann Karber or Taylor calculations. The Log Reduction Value (LRV) is then calculated as a ratio of the initial and final virus titers. When virus is undetectable following detergent treatment, the LRV is limited by the assay limit of detection, which depends on the starting virus concentration, dilution performed to negate any cytotoxic effects and the sample volume assayed and is indicated numerically as a minimum value or graphically with an upward arrow or other symbol.

### Method 2: Critical Micelle Concentration (CMC) Determination

The critical micelle concentration of the C11-C15 secondary alcohol ethoxylate is determined at different temperatures and in different media.

The CMC is determined by measuring the static surface tension of several surfactant solutions at different concentrations. The static surface tension values are plotted in function of the logarithm of the surfactant concentration. The CMC corresponds to the concentration point (or narrow range) at which a sharp change of the slope occurs. Further details of the method are provided in the guideline ISO 4311 (ISO. 1979. “Anionic and Non-Ionic Surface Active Agents—Determination of the Critical Micellization Concentration. Method by Measuring Surface Tension with a Plate, Stirrup or Ring.” ISO 4311-1979 (E)).

The static surface tension is measured by using a Force Tensiometer K100C (Krüss GmbH). The Wilhelmy plate was employed for the measurement.

The following parameters were adopted.
Measurement temperature adjusted by a Peltier temperature controller.
Measurement time: 300 s
Data points: 50
Frequency: 1 Hz

The data are acquired until the standard deviation of the surface tension measured is less than 0.1 mN/m from its average value for 50 data points.

The solution is poured in the glass vessel of the force tensiometer K100C. The solution is allowed to reach the selected temperature. Just before starting the measurement, the Wilhelmy plate is flamed until glowing red to eliminate contaminations and assure a contact angle equal to zero.

This device is equipped with two automatic dispensers. One dispenses the liquid and the other extracts the same volume. Instead of preparing manually several solutions, only a highly concentrated solution is required as starting point. The device proceeds to execute progressive dilutions and measures the static surface tension of each one, plotting the data in a graph static surface tension vs concentration.

### Method 3: Detergent Removal in Downstream Processing: Feasibility Study

The feasibility study of the removal of detergent in downstream is performed with the following method.

Three chromatography resins are selected as example for the main chromatographic techniques. The buffers for each chromatographic step are selected based on the operator experience and the manufacturer recommendations.
Protein A: Eshmuno® Prot A, 120089
   Binding & Washing (buffer A): 25 mM Tris pH 7
   Elution (buffer B): 50 mM glycine pH 2.8
   CIP (cleaning in place): 150 mM H₃PO₄
Cation Exchange: Eshmuno® S, 1200780
   Binding & Washing (buffer A): 20 mM phosphate-buffer pH 6
   Elution (buffer B): 20 mM phosphate-buffer+1 M NaCl pH 6
   CIP: 1 M NaOH
Anion Exchange: Fractogel® EMD TMAE Hicap, 110316
   Binding & Washing (buffer A): 50 mM tris-buffer pH 9
   Elution (buffer B): 50 mM tris-buffer+1 M NaCl pH 9
   CIP: 1 M NaOH

The feasibility studies are performed with a scout column packed with one of the resins listed above.

The detergent solutions are prepared dissolving the secondary alcohol ethoxylate in buffer A. The concentration tested is ≈1% wt. (≈10 000 μg/g).

The procedure is the following.
1. Equilibration of the column (Scout column, V=1 mL) with about 10 mL buffer A
2. Sample application: about 1 mL secondary alcohol ethoxylate solution (1%). The solution weight is precisely recorded, and it will be needed for the estimation.
3. Wash the column with about 50 mL buffer A (5 fractions of 10 mL each)
4. Elution with about 10 mL buffer B (2 fractions of 5 mL each)
5. CIP (cleaning in place) with 3 mL acid or base
   The fractions are collected and weighed and analyzed with the quantitative HPLC method described in Method 4.

### Method 4: Quantitative Detection Method of Residual Detergent

The quantitative method to detect residual detergent employs a HPLC (Agilent Technologies 1100 series) in combination with an evaporative light scattering detector (Agilent Technologies 1290 Infinity ELSD). The column used is a BIOshell A400 Protein C4, 10 cm×4.6 mm, 3.4 μm (Cat #66828-U).

The following conditions are optimized for our instrumental setup.
Mobile phase (eluent)
   A: water+0.1% TFA (Trifluoroacetic acid for spectroscopy Uvasol® Supelco)
   B: acetonitrile (Acetonitrile gradient grade for liquid chromatography LiChrosolv® Supelco)
Flow: 0.8 mL/min
Gradient:

| t (min) | % B | Valve |
|---|---|---|
| 0 | 30 | Waste |
| 3.5 | 30 | Waste-ELSD |
| 12.50 | 80 | ELSD |
| 16.00 | 80 | ELSD |
| 16.10 | 30 | ELSD |
| 22.00 | 30 | ELSD |

We use a valve that allows the mobile phase to go directly into the waste instead of the detector to protect the ELSD from high salt load at the beginning of the process.
Column temperature: 30° C.
Injection volume: 100 μL
The ELSD settings are optimized to guarantee maximum alcohol ethoxylate signal intensity. These parameters must be optimized for each device.
Evaporation temperature: 80° C.
Nebulizer temperature: 80° C.
Nitrogen gas flow: 1.2 SLM (standard L/min)
Smoothing (SMT): 30 (=3 s)
Detector Gain: 5 PTM

The limit of detection LOD and quantification LOQ are determined with a graphical method measuring the peak height (H) and the background noise height (h). Signal to noise ratio is calculated from these heights (see equation below).

$$\frac{S}{N} = \frac{2 \times H}{h}$$

The LOD and LOQ correspond to the concentrations that results in chromatograms where the S/N ratio is equal to the following values.
LOD: S/N=3
LOQ: S/N=10

Calibration standards with the following secondary alcohol ethoxylate concentration in water are prepared: 2, 5, 10, 25, 50, 100. Triplicate measurements are carried out for each sample. The calibration curve is log peak area vs log concentration because the ELSD signal is not linear.

The optimization process is carried out in the absence of proteins.

### Method 5: In Vitro Hemolysis of Fresh Human Blood

The purpose of this in vitro toxicology study is to assess potential effects on human whole blood by the C11-C15 secondary alcohol ethoxylate employed for the virus inactivation.

The in-vitro hemolysis assay evaluates hemoglobin release in the plasma (as an indicator of red blood cell lysis) following test agent exposure of human treated blood.

Hemolysis assay

| Predictive for | Hemotoxicity |
|---|---|
| Cell system | Fresh human whole blood (WB) |
| Treatment | 1 h and 4 h |
| Number of replicates | 3 technical replicates (wells) per |
| | measurement |
| | Blood from a human donor will be |
| | tested |
| Acceptance criteria | Individual donors will be assessed, |
| | no statistical analysis will be |
| | performed. |
| | Min (the minimum lysis) is set to the |
| | vehicle control, max (the maximum |
| | degree of lysis) is set to 100% |
| Negative control | PBS, 1% |
| Positive control | Triton ™ X-100, |
| | 0.00001 - 0.0001 - 0.003 - 0.001 - |
| | 0.0025 - 0.005 - 0.01 - 0.05 - |
| | 0.1 - 1% v/v |
| Vehicle | PBS 1% |
| Test Material | 0.1 - 1 - 3 - 10 - 25 - 50 - 100 - |
| | 500 - 1000 ppm (μg/ml) |
| | (≙ 0.00001 - 0.0001 - 0.003 - |
| | 0.001 - 0.0025 - 0.005 - 0.01 - |
| | 0.05 - 0.1% v/v) |
| Compound required | 500 μL of each test substance |
| | (10% solution) |
| | 100 mL vehicle |
| Assay Kit | Cayman Hemoglobin Detection Kit |

Human blood is obtained from the volunteer panel of Merck KGaA following standard procedure. From each healthy volunteer blood will be collected into tubes already containing Li-Heparin.

For each substance and concentration tested, 500 μl (in 24 well plates) of whole blood from the human donor is pipetted into the wells of the plates. The detergents are diluted using the appropriate vehicle and then added to the blood at a maximum of 5 μl test compound.

Controls receives either the negative control (PBS 1%) or the positive control (Triton™ X-100. 0.00001-0.0001-0.0003-0.001-0.0025-0.005-0.01-0.05-0.1-1% v/v) only.

The plates are then incubated for 1 or 4 hours at room temperature and continuously shaking (100 U/min).

After the incubation, the content of each well is centrifuged at 1000 g for 10 min at 4° C. and the supernatant is transferred to a 96-well storage plate. The plate is stored at −80° C. until measurement.

The hemoglobin content is measured using the Hemoglobin Colorimetric Assay Kit (Cayman Chemicals. #700540) and Photometer Discovery HT-R (MWG).

The total hemoglobin (TBH) present in the human donor blood is determined measuring with colorimetric assay the whole blood with a dilution 1:10. The total hemoglobin present in the donor blood is necessary to calculate the % hemolysis.

$$\% hemolysis = ( {[ Hb ]}^{sample} \times 100 ) / {[ Hb ]}^{T B H}$$

[Hb]^{sample} is the hemoglobin present in each sample treated with a detergent solution at a certain concentration.

The standards for the calibration curve are prepared as in the following. The reagents are part of the kit.

| | 500 μM | | Final | Final |
|---|---|---|---|---|
| | Hemoglobin | Hemoglobin | Hemoglobin | Hemoglobin |
| | Standard | Detector | Concentration | Concentration |
| Tube | (μL) | (μL) | (μM) | (g/dL) |
| A | 0 | 500 | 0 | 0 |
| B | 10 | 490 | 10 | 0.016 |
| C | 25 | 475 | 25 | 0.040 |
| D | 50 | 450 | 50 | 0.080 |
| E | 100 | 400 | 100 | 0.160 |
| F | 150 | 350 | 150 | 0.240 |
| G | 200 | 300 | 200 | 0.320 |
| H | 250 | 250 | 250 | 0.400 |

200 μL of each Hemoglobin Standard (A-H) is added to a clear 96-well plate in duplicate. For the measurement of the treated samples, 20 μL plasma plus 180 μL hemoglobin detector reagent (in duplicates foreach sample) is mixed in the well of a 96 well plate. After an incubation of 15 minutes at roam temperature, the absorbance is read in the Photometer Discovery HT-R (MWG) at 540 nm.

The Calibration curve showing absorbance versus hemoglobin concentration is shown in FIG. 1.

### Method 6: Biodegradability Test (OECD 301 B)

The test method follows the guideline OECD 301 B (CO₂ Evolution Test) 1992-07.

| | |
|---|---|
| Inoculum | Filtrate of homogenized activated |
| | sludge from wastewater treatment |
| | plant |
| Incubation time | 28 days |
| Detection method | CO₂ measurement |
| Control | Sodium Benzoate (≈20 mg/L |
| | TOC) |
| Application method | A defined amount of sample was |
| | weighed and put in the incubation |
| | vessel |

TOC is total organic carbon.

TCO₂ is the theoretical amount of CO₂ which might be developed from the test item (expressed as mg CO₂/g test item). This value is calculated from the carbon content of the test item and the relation of molar masses of CO₂ (44.01 g/mol) and carbon (12.01 g/mol).

ThCO₂ is the theoretical amount of CO₂ which may be developed from the test item within the whole test solution (i.e., 3.5 L).

The detergent and the inoculum (i.e., activated sludge form domestic sewage) are incubated together in a mineral nutrient medium at temperature between 19 and 25° C. The test item is the only carbon and energy source. The test solutions are aerated with CO₂-free compressed air and stirred on a magnetic stirrer.

When the material is mineralized, it is converted to CO₂ which is trapped in a system of gas-washing bottles into barium hydroxide. The CO₂ is quantified by titration of the remaining barium hydroxide with HCl. The percentage of degradation is calculated comparing the amount of CO₂ measured upon degradation with the ThCO₂.

$$\% degradation = \frac{mass {CO}_{2} produced \times 100}{mass sample in test solution \times {T CO}_{2}}$$

The sample is tested in duplicate.

The amount of CO₂ derived from the inoculum is measured from two blanks control without sample. The mean of these values is subtracted from the value of the test solution with the sample.

At the end of the test (28 days), the reaction is stopped by adding 1 mL HCl concentrated, and the inorganic carbonates are made volatile.

Aeration with CO₂-free compressed air continues for an additional day to purge the remaining CO₂ off.

The validity criteria defined by the guideline OECD 301 B are the following.
The inorganic carbon content in the sample is <5% of the total carbon content
The CO₂ formation of the blanks is <40 mg CO₂/L
The positive control (sodium benzoate) meets the requirement of minimum biodegradability (i.e., >60%) in less than 10 days
The result deviation between the duplicates is <20%

### EXAMPLES

### Example 1: Virus Inactivation

Virus inactivation studies were performed according to Method 1.

FIGS. 2 to 8 and 13 to 16 show the results.

FIG. 2 shows the data for inactivation of XMuLV in an IgG-containing matrix at 1.0 and 0.5% (w/v) detergent at 25° C. Concentrated detergents are added to generate final detergent concentrations of 0.5% and 1.0% (w/v) in the virus-spiked solution. Virus inactivation over time is indicated by a reduction in virus titer (A), and the corresponding increase in Log Reduction Value (B), with increasing incubation time. Unfilled symbols indicate either maximum titer or minimum LRV, indicating that no detectable virus was observed at these time points with volume assayed, and that the value is limited by the limit of detection for the experiment.

The results show that detergent treatment in an IgG-containing solution performed at 25° C., at both 0.5% and 1.0% detergent concentrations, provides XMuLV inactivation with a LRV of at least 5.0 within 15 min with secondary alcohol ethoxylate (SAE) detergent. Inactivation efficacy is similar to that achieved with Triton™ X-100.

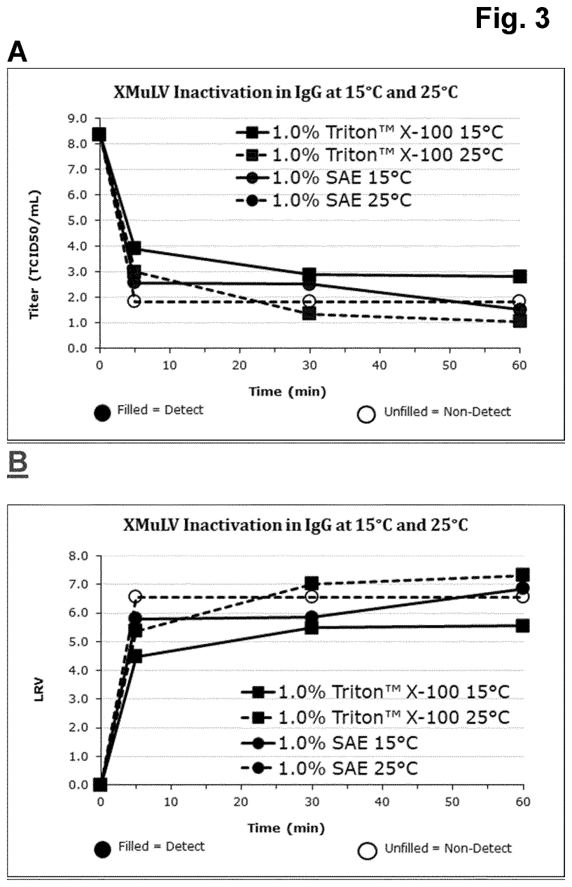

FIG. 3 shows the data for inactivation of XMuLV in an IgG-containing matrix at 1.0% detergent at 15° C. and 25° C. Concentrated detergents are added to generate a final detergent concentration of 1.0% (w/v) in the virus-spiked solution. Virus inactivation over time is indicated by a reduction in virus titer (A), and the corresponding increase in Log Reduction Value (B), with increasing incubation time.

The results show that detergent treatment in an IgG-containing matrix performed at 15° C. and 25° C., at 1.0% detergent, provides XMuLV inactivation with an LRV of at least 5.8 within 5 min with secondary alcohol ethoxylate (SAE). In this experiment, detectable residual infectious virus is observed at each incubation time point, enabling direct comparison of inactivation efficacy between SAE and Triton™ X-100. Inactivation efficacy is similar to or slightly higher than that achieved with Triton™ X-100, with SAE inactivation efficacy slightly higher than Triton™ X-100 (~1.0 log) at the lower incubation temperature.

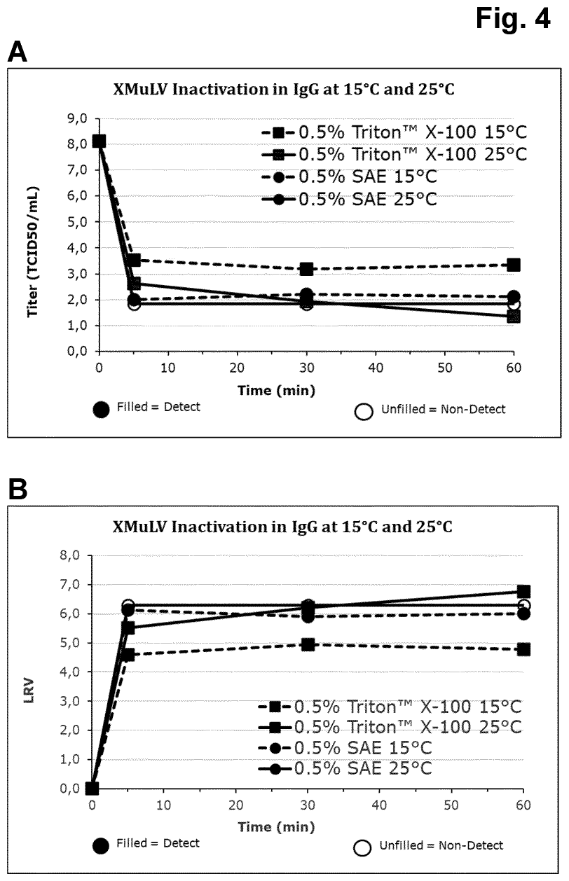

FIG. 4 shows the data for inactivation of XMuLV in an IgG-containing matrix with 0.5% secondary alcohol ethoxylate (SAE) and Triton™ X-100 detergents in an IgG-containing matrix at 15° C. and 25° C. Concentrated detergents are added to generate final detergent concentration of 0.5% (w/v) in the virus-spiked solution. Virus inactivation over time is indicated by a reduction in virus titer (A), and the corresponding increase in Log Reduction Value (B), with increasing incubation time. Unfilled symbols indicate either maximum titer or minimum LRV, indicating that no detectable virus was observed at these time points with volume assayed, and that the value is limited by the limit of detection for the experiment. The results show that detergent treatment of an IgG-containing matrix performed at 15° C. and 25° C., with 0.5% detergent, provides XMuLV inactivation with an LRV of at least 6.0 within 5 min of incubation at both incubation temperatures with secondary alcohol ethoxylate (SAE) detergent. In this experiment, detectable residual virus is observed at each incubation time point, enabling direct comparison of inactivation efficacy between SAE and Triton™ X-100. Inactivation efficacy at this 0.5% concentration is similar to or slightly higher than that achieved with Triton™ X-100, with SAE inactivation efficacy slightly higher at the lower incubation temperature.

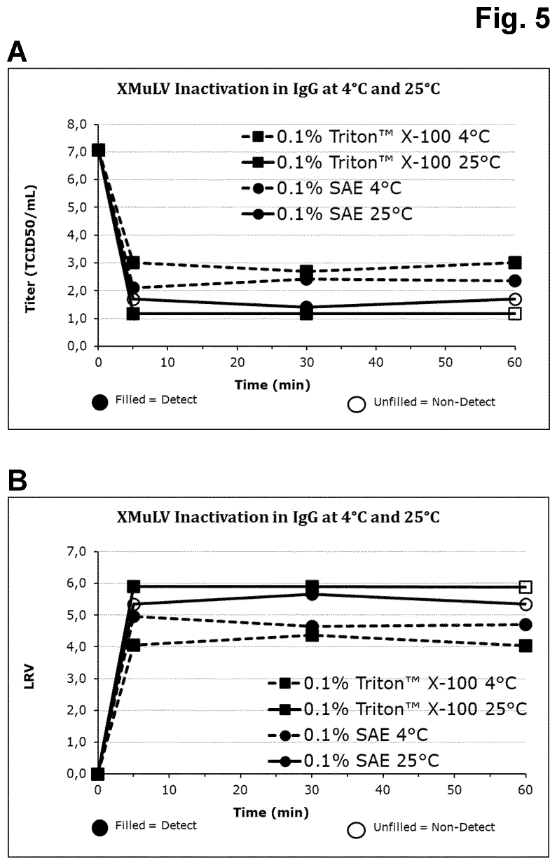

FIG. 5 shows the data for inactivation of XMuLV in an IgG-containing matrix at 0.1% secondary alcohol ethoxylate (SAE) and Triton™ X-100 detergents at 4° C. and 25° C. Concentrated detergents are added to generate final detergent concentrations of 0.1% (w/v) in the virus-spiked matrix. Virus inactivation over time is indicated by a reduction in virus titer (A), and the corresponding increase in Log Reduction Value (B), with increasing incubation time.

The results show that detergent treatment in an IgG-containing solution performed at 25° C., at a sub-optimal 0.1% detergent concentration, provides XMuLV inactivation with an LRV of 5-6 within 5 min at an incubation temperature of 25° C. with secondary alcohol ethoxylate. At the 4° C. incubation temperature, most inactivation occurred rapidly, within 5 min. Inactivation efficacy of the secondary alcohol ethoxylate shows slightly higher efficacy than Triton™ X-100 at the lower 4° C. incubation temperature, with comparable inactivation with Triton™ X-100 at the higher incubation temperature. The presence of residual detectable virus at the low detergent concentration, even at extended incubation times, enables direct comparison of the inactivation LRV.

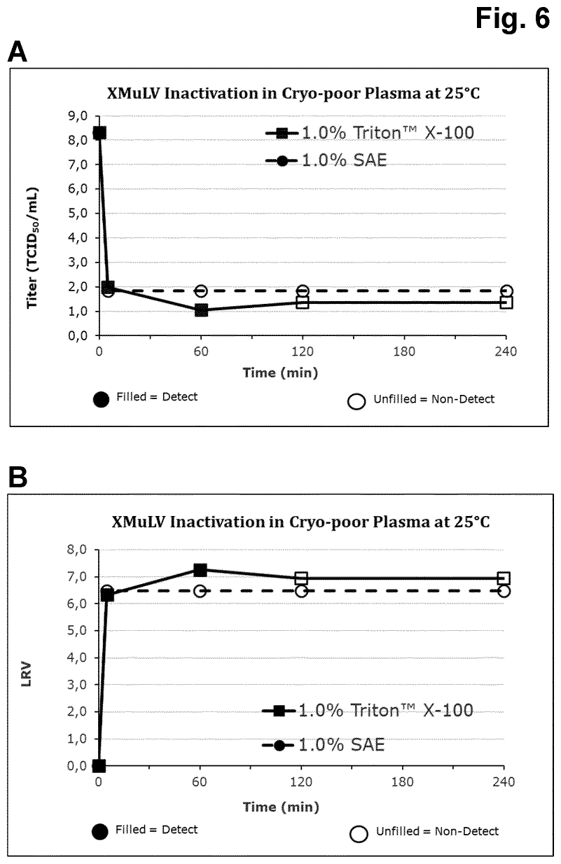

FIG. 6 shows the data for inactivation of XMuLV in cryopoor plasma with 1.0% secondary alcohol ethoxylate (SAE) and Triton™ X-100 detergents with 0.3% TnBP solvent at 25° C. A concentrated solvent/detergent mix is added to generate a final detergent concentration of 1.0% (w/v) detergent and 0.3% (v/v) TnBP solvent in the virus-spiked matrix. Virus inactivation over time is indicated by a reduction in virus titer (A), and the corresponding increase in Log Reduction Value (B), with increasing incubation time.

The results show that solvent/detergent treatment with a cryopoor plasma matrix performed at 25° C., at 1.0% detergent/0.3% TnBP provides XMuLv inactivation with an LRV of at least 6.0 within 15 min with secondary alcohol ethoxylate. Inactivation efficacy is similar to that achieved with Triton™ X-100.

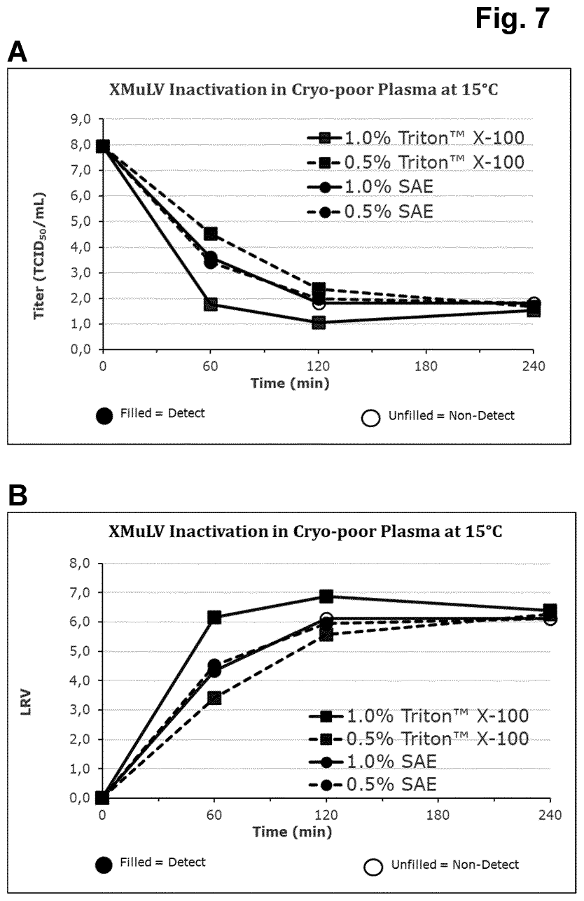

FIG. 7 shows the data for inactivation of XMuLV in cryopoor plasma with 1.0 and 0.5% secondary alcohol ethoxylate (SAE) and Triton™ X-100 detergents with 0.3% TnBP solvent at 15° C. A concentrated solvent/detergent mix is added to generate final detergent concentrations of 0.5% and 1.0% (w/v) detergent and 0.3% (v/v) TnBP solvent in the virus-spiked matrix. Virus inactivation over time is indicated by a reduction in virus titer (A), and the corresponding increase in Log Reduction Value (B), with increasing incubation time.

The results show that solvent/detergent treatment of a cryopoor plasma matrix, performed at 15° C., at both 0.5% and 1.0% detergent concentrations with 0.3% TnBP, provides XMuLV inactivation with an LRV of ~6.0 within 120 min with secondary alcohol ethoxylate detergent. Inactivation efficacy is lower than that achieved with 1.0% Triton™ X-100, until a longer incubation time has elapsed.

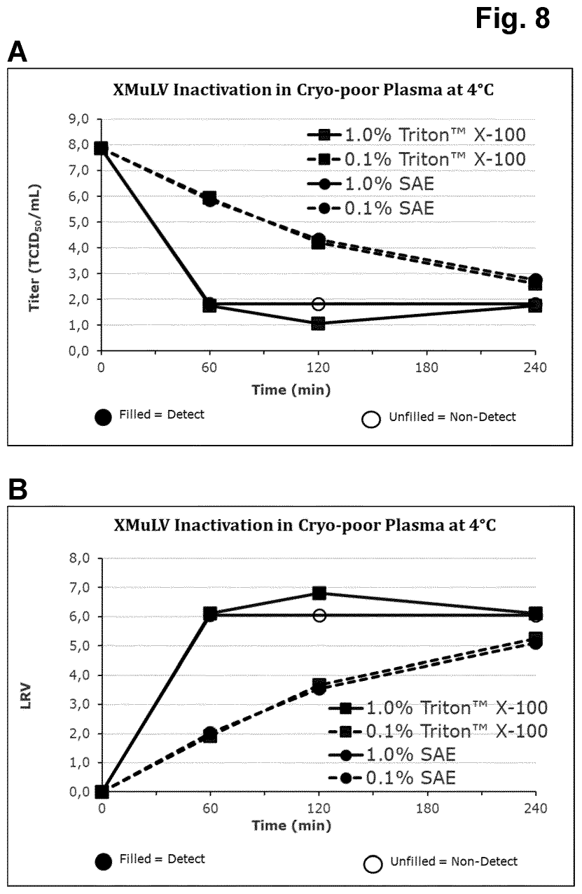

FIG. 8 shows the data for inactivation of XMuLV in cryo-poor plasma with 1.0 and 0.1% secondary alcohol ethoxylate (SAE) and Triton™ X-100 detergents with TnBP solvent at 4° C. A concentrated solvent/detergent mix is added to generate final detergent concentrations of 0.1% and 1.0% (w/v) detergent and 0.3% TnBP solvent in the virus-spiked matrix. Virus inactivation over time is indicated by a reduction in virus titer (A), and the corresponding increase in Log Reduction Value (B), with increasing incubation time.

The results show that solvent/detergent treatment in a cryo-poor plasma matrix provides XMuLV inactivation with an LRV of at least 6.0 within 60 min with 1.0% secondary alcohol ethoxylate detergent (SAE).

Inactivation efficacy is comparable to that achieved with Triton™ X-100 at comparable detergent concentrations in the presence of 0.3% TnBP solvent. At the sub-optimal 0.1% detergent concentration, with detectable virus, comparable results indicate that SAE provides the same virus inactivation efficacy as Triton™ X-100.

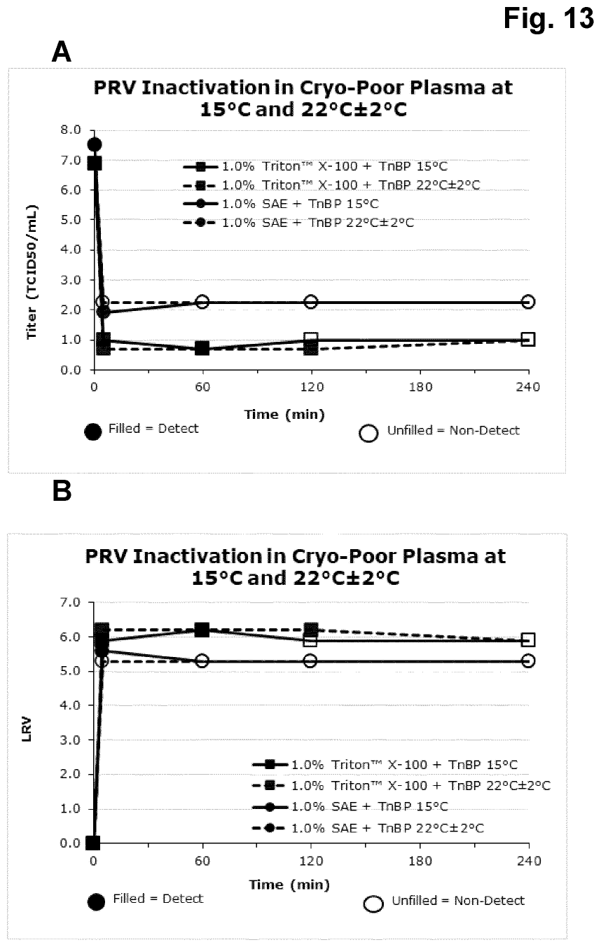

FIG. 13 shows the data for inactivation of PRV in cryo-poor plasma with 1.0% secondary alcohol ethoxylate (SAE) and Triton™ X-100 detergents with TnBP solvent at 15° C. and 22±2° C. A concentrated solvent/detergent mix is added to generate a final detergent concentration of 1.0% (w/v) detergent and 0.3% TnBP solvent in the virus-spiked matrix. Virus inactivation over time is indicated by a reduction in virus titer (A) and the corresponding increase in Log Reduction Value (B), with increasing incubation time. The results show that solvent/detergent treatment in a cryo-poor plasma matrix provides PRV inactivation with an LRV of 2:5.0 within 5 min with 1.0% secondary alcohol ethoxylate detergent (SAE) at both 15° C. and 22±2° C. Inactivation efficiency is similar to that achieved with Triton™ X-100, although direct comparison is limited by non-detectable PRV and the limit of detection imposed by the required sample dilution.

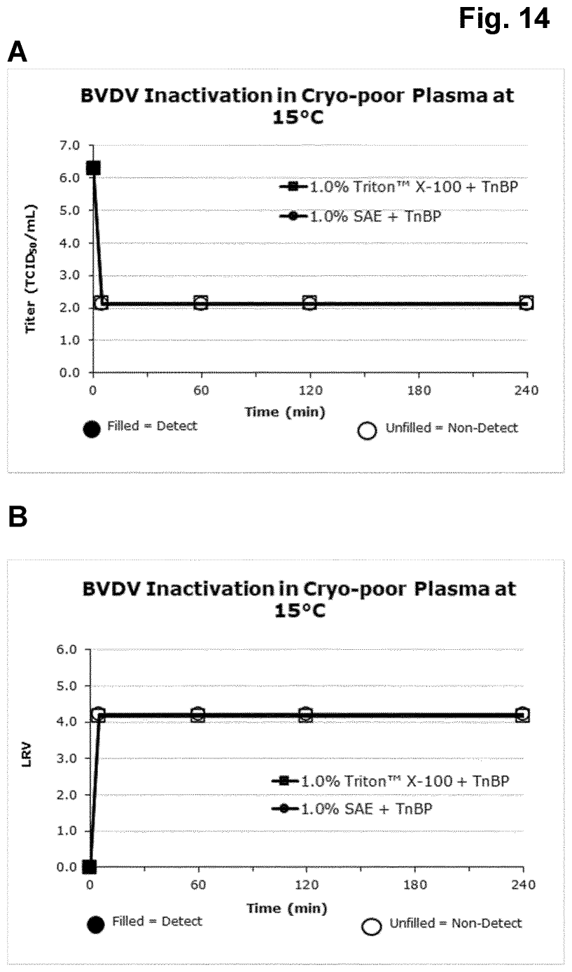

FIG. 14 shows the data for inactivation of BVDV in cryo-poor plasma with 1.0% secondary alcohol ethoxylate (SAE) and Triton™ X-100 detergents with TnBP solvent at 15° C. A concentrated solvent/detergent mix is added to generate a final detergent concentration of 1.0% (w/v) detergent and 0.3% TnBP solvent in the virus-spiked matrix. Virus inactivation over time is indicated by a reduction in virus titer (A) and the corresponding increase in Log Reduction Value (B), with increasing incubation time. The results show that solvent/detergent treatment in a cryo-poor plasma matrix provides BVDV inactivation with an LRV of ≥4.0 within 5 min with 1.0% secondary alcohol ethoxylate detergent (SAE) at 15° C. Inactivation efficiency is similar to that achieved with Triton™ X-100, although direct comparison is limited by non-detectable BVDV and the limit of detection imposed by the required sample dilution.

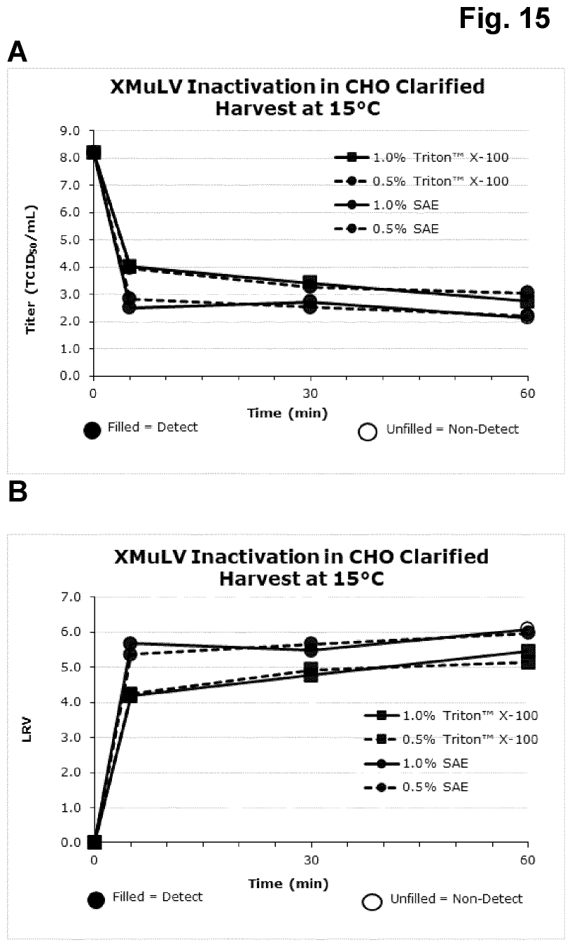

FIG. 15 shows the data for inactivation of XMuLV in CHO clarified harvest with 0.5% and 1.0% secondary alcohol ethoxylate (SAE) and Triton™ X-100 detergents at 15° C. A concentrated solvent/detergent mix is added to generate a final detergent concentration of 1.0% (w/v) detergent in the virus-spiked matrix. Virus inactivation over time is indicated by a reduction in virus titer (A) and the corresponding increase in Log Reduction Value (B), with increasing incubation time. The results show that detergent treatment in a CHO clarified harvest matrix provides XMuLV inactivation with an LRV of 2:5.0 within 5 min, and 26.0 within 60 min, with both 0.5% and 1.0% secondary alcohol ethoxylate detergent (SAE) at 15° C. Inactivation efficiency is slightly higher than that achieved with Triton™ X-100 detergent.

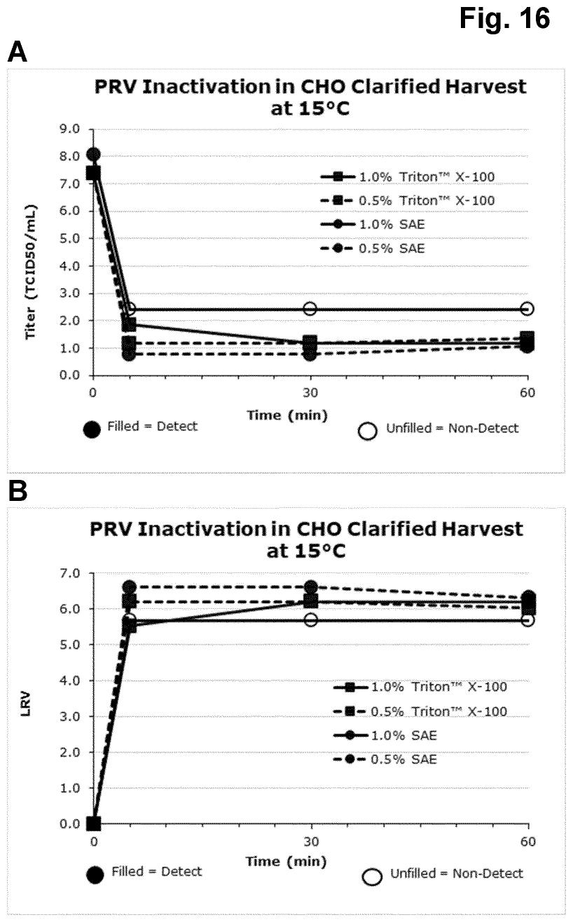

FIG. 16 shows the data for inactivation of PRV in CHO clarified harvest with 0.5% and 1.0% secondary alcohol ethoxylate (SAE) and Triton™ X-100 detergents at 15° C. A concentrated solvent/detergent mix is added to generate a final detergent concentration of 1.0% (w/v) detergent in the virus-spiked matrix. Virus inactivation over time is indicated by a reduction in virus titer (A) and the corresponding increase in Log Reduction Value (B), with increasing incubation time. The results show that detergent treatment in a CHO clarified harvest matrix provides PRV inactivation with an LRV of ≥5.0 or ~6.5 within 5 min with 1.0% or 0.5% secondary alcohol ethoxylate detergent (SAE), respectively at 15° C.

Inactivation efficiency is similar to that achieved with Triton™ X-100. Lower detergent concentration enables a lower limit of detection, and thus higher LRV demonstration due to different dilutions used to avoid cytotoxicity.

### Example 2: Quantitative Detection Method of Residual Detergent

The quantitative detection method of residual detergent is crucial to detect if residual levels of detergent are present in the purified final product. Potential undetected detergent traces in the final product could be harmful to the patient.

The limit of detection (LOD) and limit of quantification (LOQ) were calculated with the graphical method mentioned in Method 4.
LOQ: 5 μg/mL
LOD: 2 μg/mL

These limits refer to our setup and measuring conditions and to samples without proteins.

The calibration curve was obtained by measuring 7 solutions with different concentrations.

| | mean | | |
|---|---|---|---|
| Concentration | peak | log | |
| (ppm) | area¹ | concentration | Log area |
| 2 | 6655 | 0.3 | 3.8 |
| 5 | 24859 | 0.7 | 4.4 |
| 10 | 76194 | 1 | 4.9 |
| 25 | 364432 | 1.4 | 5.6 |
| 50 | 1132354 | 1.7 | 6.1 |
| 100 | 3331069 | 2 | 6.5 |

¹mean value of triplicates

FIG. 9 shows the calibration curve with mean peak area versus concentration.

### Example 3: Detergent Removal in Downstream Processing: Feasibility Study

Detergent removal after the virus inactivation step can take place in one or multiple steps of the downstream processing. The detergent is preferably added after clarification, but it can also be employed before or in between the different purification steps. To assess the complete removal of detergent with the different chromatographic techniques involved, three techniques have been tested: affinity chromatography with Protein A, cation exchange and anion exchange.

The feasibility study has been performed packing a scout column with the three different resins and equilibrating it with the appropriate buffer.

The person skilled in the art knows which buffers are the most appropriate for each resin and for each chromatographic step, such as washing, elution and CIP (i.e., cleaning in place). In the feasibility study the detergent was applied to the column as a 1% wt. solution in the washing buffer. This concentration has been selected as representative of common industrial processes. In these series of experiments no proteins are present.

The complete procedure is reported in Method 3.

By using the calibration curve described in Example 2 the following residual C11-C15 secondary alcohol ethoxylate concentration were detected:

| | | |
|---|---|---|
| | | Detergent conc. |
| Purification step | Detergent conc. | in eluate after |
| (resin) | before purification | purification |

| Protein A | 9663 | μg/g | <LOD |
|---|---|---|---|
| (Eshmuno ® Prot A) | | | |
| Cation Exchange | 9060 | μg/g | <LOD |
| (Eshmuno ® S) | | | |
| Anion Exchange | 10 957 | μg/g | <LOD |

(Fractogel ® EMD
TMAE Hicap)

This feasibility study showed that the detergent was easily removed with all three chromatographic techniques, affinity chromatography with protein A, cation, and anion exchange. No traces of detergent were detected in the eluate and CIP fractions.

### Example 4: In Vitro Hemolysis of Fresh Human Blood

Hemocompatibility tests, such as the measurement of hemolysis are recommended for the evaluation of medical devices, materials and/or their extracts (ISO 10993-1:2009). Blood from one male healthy volunteer was treated with 9 concentrations (from 0.00001% up to 0.1%) for 4 h. Hemolysis was then monitored by the release of hemoglobin (Hb) from the red blood cells.

In this invention, the in vitro hemolysis assay of human blood was performed to determine the level of residual detergent that is acceptable for patients. According to WHO Technical Report Series 924, the permitted level of Triton™ X-100 is between 3 and 25 ppm, depending on volume and frequency of infusion. This assay is carried out to evaluate if the same concentration range would be acceptable for the C11-C15 secondary alcohol ethoxylate.

According to hemocompatibility literature (ASTM F756) a substance is classified as slightly hemolytic when the hemolysis percentage is between 2 and 5% and hemolytic when this percentage is above 5%. The negative control (PBS 1% v/v) showed no effect on human blood after 4 h.

The positive control, Triton™ X-100 showed a hemolytic effect at the three highest concentrations 1%, 0.1% and 0.05% v/v after 4 h.

The secondary alcohol ethoxylate that we propose as virus inactivation detergent is below the threshold of 2% hemolysis even at 100 ppm with the 4 hours assay.

FIG. 10 shows the hemolysis percentage as a function of detergent concentration after 4 hours.

The results show that the secondary alcohol ethoxylate is comparable to Triton™ X-100.

### Example 5: Biodegradability Test (OECD 301 B)

The carbon content of the sample was calculated from TOC measurement (according to the DIN EN ISO 16948) and it was equal to 619.0 mg C/g test item.

$$\frac{molar mass {CO}_{2}}{molar mass C} = \frac{44.01}{12.01} = 3 \text{.667}$$

$${T CO}_{2} = 2268.29 mg {CO}_{2} / g test item$$

The validity criteria were fulfilled.
The inorganic carbon content of the sample in the test solution was <5% of the total carbon content
The CO₂ formation of the blanks was 37.79 mg/L, therefore <40 mg/L
The positive control passed the threshold of biodegradability of 60% within 6 days and 80% was degraded in 28 days.
The two replicates had a result deviation <20%

| | Concentration: 59.00 mg/3.5 L ThCO₂: 133.83 mg CO₂/3.5 L | |
|---|---|---|
| | mg CO₂ produced in | |
| Time | the Test solution. | % ThCO₂ |
| [d] | cumulative | (=% Degradation) |
| 3 | 0.49 | 0 |
| 6 | 17.76 | 13 |
| 9 | 37.06 | 28 |
| 14 | 56.62 | 42 |
| 17 | 69.48 | 52 |
| 21 | 80.45 | 60 |
| 28 | 86.63 | 65 ¹⁾ |
| 29 | 96.37 | 72 |

¹⁾ The test solution was stopped at time 28 d by the addition of 1 mL conc. HCl. The final titration was performed at time t_{29 d}.

### Test Solution 1 (Secondary Alcohol Ethoxylate, First Replicate)

| | Concentration: 59.60 mg/3.5 L ThCO₂: 135.19 mg CO₂/3.5 L | |
|---|---|---|
| | mg CO₂ produced in | |
| Time | the Test solution. | % ThCO₂ |
| [d] | cumulative | (=% Degradation) |
| 3 | 0.87 | 1 |
| 6 | 19.74 | 15 |
| 9 | 38.77 | 29 |
| 14 | 60.10 | 44 |
| 17 | 73.31 | 54 |
| 21 | 83.46 | 62 |
| 28 | 93.28 | 69 ¹⁾ |
| 29 | 102.75 | 76 |

¹⁾ The test solution was stopped at time 28 d by the addition of 1 mL conc. HCl. The final titration was performed at time t_{29 d}.

### Test Solution 2 (Secondary Alcohol Ethoxylate, Second Replicate)

| | Concentration: 128.60 mg Sodium Benzoate + 60.00 mg Test Item | |
|---|---|---|
| | ThCO₂: 410.34 mg CO₂/3.5 L | |
| | mg CO₂ produced in | |
| Time | the Test solution. | % ThCO₂ |
| [d] | cumulative | (=% Degradation) |
| 3 | 84.46 | 21 |
| 6 | 153.77 | 37 |
| 9 | 207.30 | 51 |
| 14 | 256.56 | 63 |
| 17 | 269.09 | 66 |
| 21 | 284.50 | 69 |
| 28 | 297.12 | 72 ¹⁾ |
| 29 | 317.23 | 77 |

¹⁾ The test solution was stopped at time 28 d by the addition of 1 mL conc. HCl. The final titration was performed at time t_{29 d}.

### Toxicity Control: Sodium Benzoate+Secondary Alcohol Ethoxylate

| | Concentration: 128.70 mg/3.5 L ThCO₂: 274.46 mg CO₂/3.5 L | |
|---|---|---|
| | mg CO₂ produced in | |
| Time | the Test solution. | % ThCO₂ |
| [d] | cumulative | (=% Degradation) |
| 3 | 124.18 | 45 |
| 6 | 172.37 | 63 |
| 9 | 184.31 | 67 |
| 14 | 195.89 | 71 |
| 17 | 203.73 | 74 |
| 21 | 211.06 | 77 |
| 28 | 214.23 | 78 ¹⁾ |
| 29 | 218.94 | 80 |

¹⁾ The test solution was stopped at time 28 d by the addition of 1 mL conc. HCl. The final titration was performed at time t_{29 d}.

### Positive Control: Sodium Benzoate

The mean % degradation of the two replicates was 67% within 28 days. The threshold of biodegradability of ≥60% within 28 days was therefore met by both replicates. The results are represented graphically in FIG. 11.

According to the results of the toxicity control, a toxic effect of the secondary alcohol ethoxylate towards microorganisms at the concentration tested (i.e., 17 mg/L) can be excluded.

### Example 6: Critical Micelle Concentration (CMC) Determination

The critical micelle concentration is determined according to Method 2. The surface tension values measured for each dilution are plotted in a graph static surface tension vs concentration. The concentration axis is in logarithmic base. The critical micelle concentration is the concentration (or the narrow range of concentrations) corresponding to the beginning of the micelle self-assembly. From this concentration (or narrow range) on, an increase of surfactant concentration does not affect the surface tension and the plot of surface tension vs concentration is a horizontal line. The CMC corresponds to the concentration point (or narrow range) at which a sharp change of the slope occurs. In FIG. 12 the CMC of the secondary alcohol ethoxylate in Milli-Q water at 23.9° C. is equal to 49 mg/L.

1. A method for inactivating enveloped viruses in a sample by
a) providing the sample,
b) adding to the sample one or more compounds of Formula I at a final concentration above their CMC; and
c) incubating the mixture; 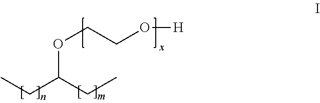
with x=7 to 15
and n+m=8 to 12.

2. The method according to claim 1, characterized in that x=9.

3. The method according to claim 1, characterized in that the one or more compounds are a C11-C15 secondary alcohol ethoxylate according to CAS 68131-40-8 and/or a C12-C14 secondary alcohol ethoxylate according to CAS 84133-50-60.

4. The method according to claim 1, characterized in that the sample comprises a target protein.

5. The method according to claim 1, characterized in that step c) is performed for a time between 5 minutes and 6 hours.

6. The method according to claim 1, characterized in that step c) is performed at a temperature between 4 and 25° C.

7. The method according to claim 1, characterized in that in step c) a pH of the sample during incubation is between pH 5.5 and pH 8.

8. The method according to claim 1, characterized in that an overall concentration of the one or more compounds according to Formula I is between 0.05 and 2% weight per volume (w/v).

9. The method according to claim 1, characterized in that in step b), in addition to the one or more compounds according to Formula I, a solvent is added to the sample.

10. The method according to claim 1, characterized in that the sample is a clarified harvest, a chromatography pool or a plasma sample.
